(19) United States
(12) Patent Application Publication
(10) Pub. No.: US 2026/0010719 A1
(43) Pub. Date: Jan. 8, 2026

(54) METHOD AND SYSTEM FOR AUTOMATED REAL-TIME NEWS ALERTING AT SCALE

(71) Applicant: JPMorgan Chase Bank, N.A., New York, NY (US)

(72) Inventors: Florenz Allewijn Pieter HOLLEBRANDSE, Glasgow (GB); Jonathan CAMERON, Glasgow (GB)

(73) Assignee: JPMorgan Chase Bank, N.A., New York, NY (US)

(21) Appl. No.: 18/762,002

(22) Filed: Jul. 2, 2024

(51) Int. Cl. G06F 40/279; G06F 16/383; G06Q 40/03

(52) U.S. Cl. CPC G06F 40/279; G06F 16/383; G06Q 40/03

(57) ABSTRACT

A method and a system for issuing news alerts with respect to an entity are provided. The method includes: receiving a news article that relates to at least one entity; extracting, from the input information, signal data; generating a news article electronic document including the news article and the signal data; extracting, from the news article electronic document, a signal quantity for each entity of the at least one entity; generating a time series of signal quantities for the news article; storing each of the news article electronic document and the time series in a database; transmitting the time series to a news alerting model that compares the signal quantity of each entity from the time series to a respective baseline value of the corresponding entity; and generating an alert message when the signal quantity exceeds the baseline value by a predetermined threshold value.

### BACKGROUND

### 1. Field of the Disclosure

This technology generally relates to methods and systems for issuing news alerts with respect to an entity, and more particularly to methods and systems for efficiently storing and retrieving news articles and associated analytical data/quantities to issue real-time alerts for managing credit risk.

### 2. Background Information

For a large financial institution, many business decisions, such as decisions regarding client credit limits, are made by many different groups on a daily basis. Credit reviews may be required due to significant events related to a client, which may be covered by global/regional press.

Credit officers need to monitor news about clients in their portfolio in order to manage the associated risk appropriately. Many credit officers have large numbers of clients, and the news items that relate to such clients is of varying newsworthiness, and as a result, monitoring the news can be time-consuming and difficult to perform on an ongoing basis.

Additionally, current alerting systems are inefficient at querying and extracting baseline values for each company in news article, in order to trigger appropriate alerts in real-time. Moreover, database queries against the store of news articles over long baseline periods may be inefficient depending on the database technology, as news articles may be associated with multiple companies (of which some companies may not be relevant and/or material to the desired analysis).

Accordingly, there is a need for systems and methods that are designed to deliver real-time alerts about significant news events to various recipients in order to efficiently store and retrieve news articles and associated analytical data/quantities to issue real-time alerts for managing credit risk.

### SUMMARY

The present disclosure, through one or more of its various aspects, embodiments, and/or specific features or sub-components, provides, inter alia, various systems, servers, devices, methods, media, programs, and platforms for efficiently storing and retrieving news articles and associated analytical data/quantities to issue real-time alerts for managing credit risk.

According to an aspect of the present disclosure, a method for issuing news alerts with respect to an entity is provided. The method is implemented by at least one processor. The method includes: receiving, by the at least one processor, a news article that relates to at least one entity; analyzing, by the at least one processor, the news article in order to determine whether the news article contains important content; when a determination is made that the news article contains important content as a result of the analyzing, determining, by the at least one processor, whether the at least one entity is mentioned in the news article; determining, by the at least one processor, input parameters that relate to the at least one entity; extracting, by the at least one processor from the input parameters, signal data; generating, by the at least one processor, a news article electronic document including the news article and the signal data; extracting, by the at least one processor from the news article electronic document, a signal quantity for each entity of the at least one entity; generating, by the at least one processor, a time series of signal quantities for the news article; storing, by the at least one processor, each of the news article electronic document and the time series in a database; transmitting, by the at least one processor, the time series to a news alerting model that compares the signal quantity of each entity from the time series to a respective baseline value of the corresponding entity; and generating, by the at least one processor, an alert message when the signal quantity exceeds the baseline value by a predetermined threshold value.

The method may further include generating, by the at least one processor, a plurality of time series records for each entity, wherein each time series record of the plurality of time series records comprises each respective time series for a corresponding entity from each news article published during a first predetermined time period.

The method may further include generating, by the at least one processor, the respective baseline value for the corresponding entity by querying the plurality of time series records for the respective entity over a second predetermined time period and computing at least one of a mean, median, standard deviation, count, and percentile.

The time series may include at least one from among a date, an entity identifier, a quantity type, a news article identifier, and a quantity value that is sequence matched with the news article identifier.

The signal data may include at least one from among a sentiment category, a sentiment score, and a probability of whether the news article mentions mergers and acquisitions activity related to at least one of the at least one entity.

The determining of whether the at least one entity is mentioned in the news article, the analyzing of the news article to determine whether the news article contains important content, and the determining of the information that relates to a sentiment that relates to the at least one entity may be performed by an artificial intelligence (AI) model that appends the signal data to the news article electronic document.

The analyzing may comprise determining whether the news article contains information that is negative with respect to the entity, and when a determination is made that the news article contains information that is negative with respect to the entity, determining that the information that is negative with respect to the entity is important content.

The analyzing may comprise determining whether the news article contains information that relates to merger and acquisition activity with respect to the entity, and when a determination is made that the news article contains information that relates to merger and acquisition activity with respect to the entity, determining that the information that relates to the merger and acquisition activity with respect to the entity is important content.

The method may further include transmitting, by the at least one processor to a predetermined destination, the alert message and the signal data that corresponds to the news article such that a user interface associated with the predetermined destination is caused to display the transmitted information, and wherein the alert message includes a notification that the news article contains important content.

According to another aspect of the present disclosure, a computing apparatus for issuing news alerts with respect to an entity is provided. The computing apparatus includes a processor; a memory; and a communication interface coupled to each of the processor, and the memory. The processor is configured to: receive, via the communication interface, a news article that relates to at least one entity; analyze the news article in order to determine whether the news article contains important content; when a determination is made that the news article contains important content as a result of the analyzing, determine whether the at least one entity is mentioned in the news article; determine input parameters that relate to the at least one entity; extract, from the input parameters, signal data; generate a news article electronic document including the news article and the signal data; extract, from the news article electronic document, a signal quantity for each entity of the at least one entity; generate a time series of signal quantities for the news article; store each of the news article electronic document and the time series in a database; transmit the time series to a news alerting model that compares the signal quantity of each entity from the time series to a respective baseline value of the corresponding entity; and generate an alert message when the signal quantity exceeds the baseline value by a predetermined threshold value.

The processor may be further configured to generate a plurality of time series records for each entity, wherein each time series record of the plurality of time series records comprises each respective time series for a corresponding entity from each news article published during a first predetermined time period.

The processor may be further configured to generate the respective baseline value for the corresponding entity by querying the plurality of time series records for the respective entity over a second predetermined time period and computing at least one of a mean, median, standard deviation, count, and percentile.

The time series may include at least one from among a date, an entity identifier, a quantity type, a news article identifier, and a quantity value that is sequence matched with the news article identifier.

The signal data may include at least one from among a sentiment category, a sentiment score, and a probability of whether the news article mentions mergers and acquisitions activity related to at least one of the at least one entity.

The processor may be further configured to determine whether at least one entity is mentioned in the news article, analyze the news article to determine whether the news article contains important content, and determine the information that relates to a sentiment that relates to the at least one entity by applying an AI model that appends the signal data to the news article electronic document.

The processor may be further configured to determine whether the news article contains information that is negative with respect to the entity, and when a determination is made that the news article contains information that is negative with respect to the entity, determine that the information that is negative with respect to the entity is important content.

The processor may be further configured to determine whether the news article contains information that relates to merger and acquisition activity with respect to the entity, and when a determination is made that the news article contains information that relates to merger and acquisition activity with respect to the entity, determine that the information that relates to the merger and acquisition activity with respect to the entity is important content.

The processor may be further configured to transmit, via the communication interface to a predetermined destination, the alert message and the signal data that corresponds to the news article such that a user interface associated with the predetermined destination is caused to display the transmitted signal data, and the alert message may include a notification that the news article contains important content.

According to yet another aspect of the present disclosure, a non-transitory computer readable storage medium storing instructions for issuing news alerts with respect to an entity is provided. The storage medium includes executable code which, when executed by a processor, causes the processor to: receive a news article that relates to at least one entity; analyze the news article in order to determine whether the news article contains important content; when a determination is made that the news article contains important content as a result of the analyzing, determine whether the at least one entity is mentioned in the news article; determine input parameters that relate to the at least one entity; extract, from the input parameters, signal data; generate a news article electronic document including the news article and the signal data; extract, from the news article electronic document, for each entity of the at least one entity a signal quantity; generate a time series of signal quantities for the news article; store each of the news article electronic document and the time series in a database; transmit the time series to a news alerting model that compares the signal quantity of each entity from the time series to a respective baseline value of the corresponding entity; and generate an alert message when the signal quantity exceeds the baseline value by a predetermined threshold value.

The storage medium may be further configured to generate a plurality of time series records for each entity, wherein each time series record of the plurality of time series records comprises each respective time series for a corresponding entity from each news article published during a first predetermined time period.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system, according to an embodiment.

FIG. 2 illustrates a network diagram of a network environment, according to an embodiment.

FIG. 3 illustrates a system diagram of a system, according to an embodiment.

FIG. 4 illustrates a process diagram of a process for efficiently storing and retrieving news articles and associated analytical data/quantities to issue real-time alerts for managing credit risk.

FIG. 5 illustrates a flow diagram of a process for efficiently storing and retrieving news articles and associated analytical data/quantities to issue real-time alerts for managing credit risk.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

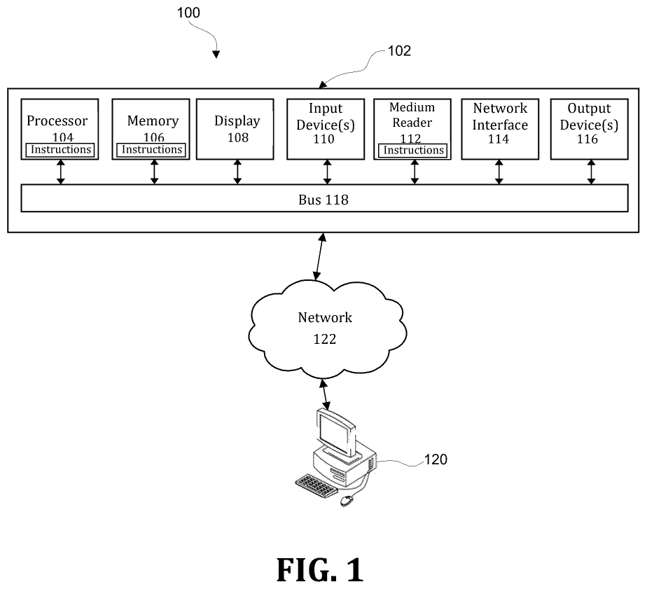

FIG. 1 illustrates a system diagram of a system 100 in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for efficiently storing and retrieving news articles and associated analytical data/quantities to issue real-time alerts for managing credit risk.

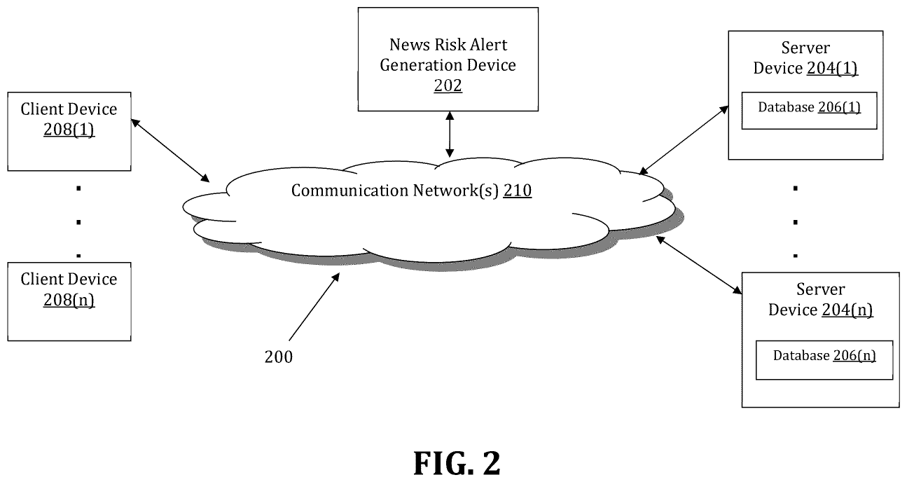

Referring to FIG. 2, a schematic of a network environment 200 for implementing a method for efficiently storing and retrieving news articles and associated analytical data/quantities to issue real-time alerts for managing credit risk is illustrated. In some embodiments, the method may be executable on any networked computer platform, such as, for example, a personal computer (PC).

The method for efficiently storing and retrieving news articles and associated analytical data/quantities to issue real-time alerts for managing credit risk may be implemented by a news risk alert generation device 202. The news risk alert generation device 202 may be the same or similar to the computer system 102 as described with respect to FIG. 1. The news risk alert generation device 202 may store one or more applications that can include executable instructions that, when executed by the news risk alert generation device 202, cause the news risk alert generation device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the news risk alert generation device 202 itself, may be located in virtual server(s) running in a cloud-based computing environment rather than being tied to one or more specific physical network computing devices. Also, the application(s) may be running in one or more virtual machines (VMs) executing on the news risk alert generation device 202. Additionally, in one or more embodiments of this technology, virtual machine(s) running on the news risk alert generation device 202 may be managed or supervised by a hypervisor.

In the network environment 200 of FIG. 2, the news risk alert generation device 202 is coupled to a plurality of server devices 204(1)-204(n) that hosts a plurality of databases 206(1)-206(n), and also to a plurality of client devices 208(1)-208(n) via communication network(s) 210. A communication interface of the news risk alert generation device 202, such as the network interface 114 of the computer system 102 of FIG. 1, operatively couples and communicates between the news risk alert generation device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the news risk alert generation device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and news risk alert generation devices that efficiently implement a method for efficiently storing and retrieving news articles and associated analytical data/quantities to issue real-time alerts for managing credit risk.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The news risk alert generation device 202 may be a standalone device or integrated with one or more other devices or apparatuses, such as one or more of the server devices 204(1)-204(n), for example. In one particular example, the news risk alert generation device 202 may include or be hosted by one of the server devices 204(1)-204(n), and other arrangements are also possible. Moreover, one or more of the devices of the news risk alert generation device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the news risk alert generation device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to raw news data repository and a document database.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the news risk alert generation device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 is a wireless mobile communication device, i.e., a smart phone.

The client devices 208(1)-208(n) may run interface applications, such as standard web browsers or standalone client applications, which may provide an interface to communicate with the news risk alert generation device 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the news risk alert generation device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are mere examples, as many variations of the specific hardware and software used to implement the examples are possible, as will be appreciated by those skilled in the relevant art(s).

One or more of the devices depicted in the network environment 200, such as the news risk alert generation device 202, the server devices 204(1)-204(n), or the client devices 208(1)-208(n), for example, may be configured to operate as virtual instances on the same physical machine. In other words, one or more of the news risk alert generation devices 202, the server devices 204(1)-204(n), or the client devices 208(1)-208(n) may operate on the same physical device rather than as separate devices communicating through communication network(s) 210. Additionally, there may be more or fewer news risk alert generation devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

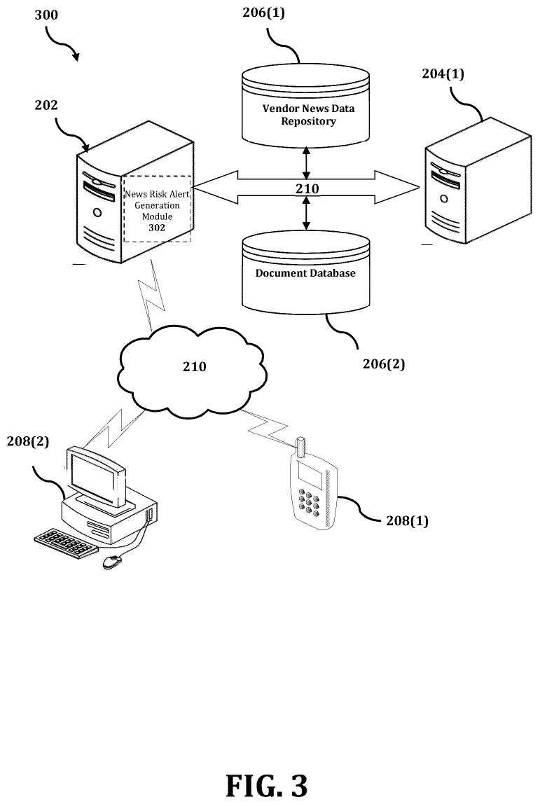

The news risk alert generation device 202 is described and illustrated in FIG. 3 as including a news risk alert generation module 302, although it may include other rules, policies, modules, databases, or applications, for example. As will be described below, the news risk alert generation module 302 is configured to implement a method for efficiently storing and retrieving news articles and associated analytical data/quantities to issue real-time alerts for managing credit risk.

A system 300 for efficiently storing and retrieving news articles and associated analytical data/quantities to issue real-time alerts for managing credit risk by utilizing the network environment of FIG. 2 is illustrated as being executed in FIG. 3. Specifically, a first client device 208(1) and a second client device 208(2) are illustrated as being in communication with the news risk alert generation device 202. In this regard, the first client device 208(1) and the second client device 208(2) may be “clients” of the news risk alert generation device 202 and are described herein as such. Nevertheless, it is to be known and understood that the first client device 208(1) and/or the second client device 208(2) need not necessarily be “clients” of the news risk alert generation device 202, or any entity described in association therewith herein. Any additional or alternative relationship may exist between either or both of the first client device 208(1) and the second client device 208(2) and the news risk alert generation device 202, or no relationship may exist.

Further, the news risk alert generation device 202 is illustrated as being able to access a vendor news data repository 206(1) and a document database 206(2). The news risk alert generation module 302 may be configured to access the repository and database for efficiently storing and retrieving news articles and associated analytical data/quantities to issue real-time alerts for managing credit risk.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the news risk alert generation device 202 via broadband or cellular communication. Of course, these embodiments are not limiting or exhaustive.

Upon being started, the news risk alert generation module 302 executes a process for efficiently storing and retrieving news articles and associated analytical data/quantities to issue real-time alerts for managing credit risk.

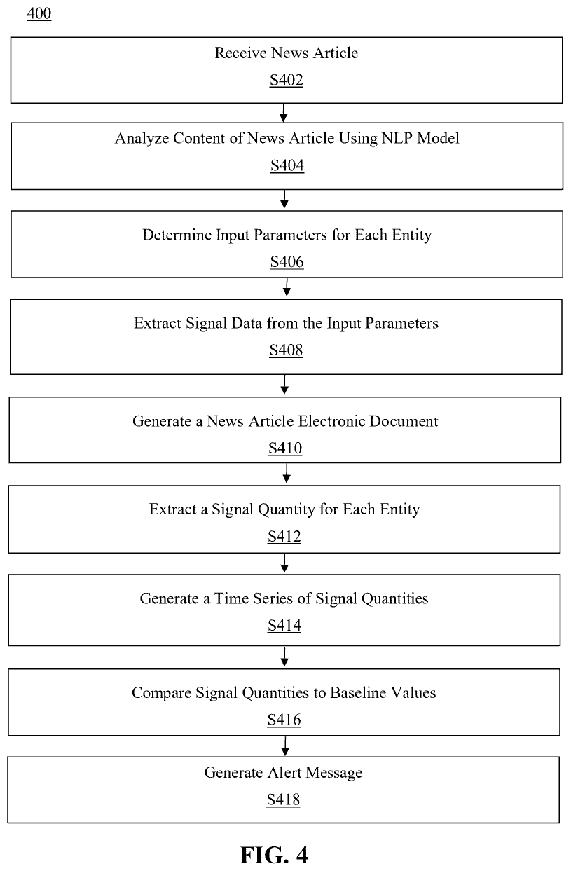

Referring to FIG. 4, a process 400 for efficiently storing and retrieving news articles and associated analytical data/quantities to issue real-time alerts for managing credit risk is illustrated, according to an embodiment.

In process 400 of FIG. 4, at step S402, the news risk alert generation module 302 may receive a news article that relates to an entity. In an embodiment, the entity may be a client of a financial institution, such as a bank, and the bank may be interested in managing a wholesale credit risk with respect to the client, in order to make wise decisions regarding whether to extend credit to the client. In an exemplary embodiment, the news article may be received via a news aggregation service, such as, for example, the Dow Jones Factiva news aggregation service. The news article may be originated by at least one source from among a plurality of sources that includes any one or more of Dow Jones, Lexis Nexis, Bloomberg, Twitter, X, JP Morgan Markets, Refinitiv, the Wall Street Journal, the Financial Times, SNL Financial, and/or any other reputable source of economic news. In some embodiments, the system may retrieve several hundred million articles per year.

At step S404, the news risk alert generation module 302 may analyze the news article in order to determine whether the news article contains important content. In some embodiments, the analysis is performed by applying multiple models that use Natural Language Processing (NLP) techniques and other AI/ML models to analyze the news article. In some embodiments, the news risk alert generation module 302 may determine each entity that is mentioned in the news article. In some embodiments, the news risk alert generation module 302 determines whether the news article contains sentiment information about an entity. When sentiment information about an entity is included in the news article, then the model may be configured to determine such information as being important content. In some embodiments, the AI/ML models may estimate a categorical or numeric value based on the text contained in the news article to determine the sentiment information.

In some embodiments, the news risk alert generation module 302 may use an artificial intelligence and machine learning (AI/ML) model to analyze the news articles. The AI/ML model may identify whether and which entities are mentioned in the news article. In an embodiment, the AI/ML model may determine whether the information regarding the entity mentioned is focal/material or whether it is just incidental.

At step S406, the news risk alert generation module 302 may determine input parameters for each entity. In some embodiments, the input parameters may include whether the news article contains negative information about the entity, whether the news article contains positive information about the entity, and whether the news article contains information that relates to merger and acquisition activity with respect to the entity.

At step S408 the news risk alert generation module 302 may extract signal data from the input parameters. In some embodiments, the signal data may include at least one from among a sentiment category, a sentiment score, and a probability of whether the news article mentions mergers and acquisitions activity related to at least one of the at least one entity. In some embodiments, the AI/ML model may determine the sentiment category or a sentiment score. In some embodiments, the sentiment category may include whether the information in the news article about the entity is negative, neutral, or positive. In some embodiments, the AI/ML models may estimate a categorical or numeric value based on the text contained in the news article to determine the input parameters. In an embodiment, the sentiment score may be within a range from −1 to +1. In some embodiments, the AI/ML model may be used to determine whether the news article mentions mergers and acquisitions activity in relation to the entity.

At step S410, the news risk alert generation module 302 may generate a news article electronic document. In some embodiments, the system may append analytical data, including signal data, to the news article electronic document. In an embodiment, the modified article is saved in a document database.

At step S412, the news risk alert generation module 302 may extract the signal quantity from each entity based on the signal data. Then, at step S414 a time series of the signal quantities is generated. In an embodiment, time signal quantities for each company from each news article are extracted and recorded as the time series. In an embodiment, each record of the time series may be associated with a key identifier consisting of the date, company identifier, and quantity. In some embodiments, the fundamental data attributes of a time series record may be a date, a company identifier, a quantity type, a collection of news article identifiers, a collection of quantity values, or a sequence matching of the article identifiers under the collection of quantity values. In some embodiments, the time series record may be saved in the document database along with the modified articles.

At step S416, the news risk alert generation module 302 may compare a signal quantity from the time series record to a baseline value for the corresponding quantity type and entity. In an embodiment, the news risk alert generation module 302 may compute the baseline value by querying the time series records from the document database for the given entity and quantity. In an embodiment, the computed baseline may be at least one of a mean, median, standard deviation, count, and percentile of the queried time series records for the respective entity over a predetermined time period. The news risk alert generation module 302 may then compute for each day the required summary statistics. The resulting baseline may then be compared with the current and recent quantities to determine whether an alert should be issued.

Then, at step S418, if the signal quantity value exceeds the baseline value, an alert may be issued. In some embodiments, the alert may be issued when the baseline value is exceeded by a predetermined threshold. In an embodiment, the threshold may be optimized using an AI/ML algorithm. In an embodiment, the news risk alert generation module 302 may generate an alert message that includes a notification that the news article contains important content. In an embodiment, the alert message may also include a name of the entity, an alert date, an alert description, and information that relates to a relevance of the news article to a credit risk profile associated with the entity. In some embodiments, the news risk alert generation module 302 may cause a user interface associated with the respective destination to display the transmitted information, so that a user is easily able to see the alert message. In an embodiment, the information that corresponds to the news article may include the entire text of the news article and/or a clickable link that facilitates an ability of the user to access the news article.

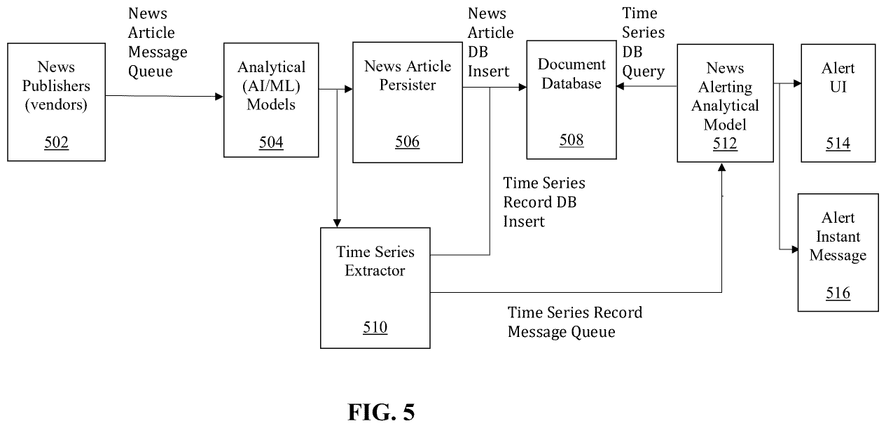

FIG. 5 illustrates a flow diagram 500 of a process for efficiently storing and retrieving news articles and associated analytical data/quantities to issue real-time alerts for managing credit risk, according to an embodiment.

As illustrated in FIG. 5, at component 502, news publishers (vendors) may publish news articles that may be relevant to a particle entity or company. In an embodiment, the one or more news publishers or news aggregators, may be an external news publisher. The news publishers may provide a real-time connection to the news risk alert generation module 302 so that the news risk alert generation module 302 may consume news articles as and when they are published or amended. In an embodiment, the news publishers may include Dow Jones, Lexis Nexis, Bloomberg, Twitter, X, JP Morgan Markets, Refinitiv, the Wall Street Journal, the Financial Times, SNL Financial, and/or any other reputable source of economic news. In an embodiment, the total number of news articles retrieved may be between 10 and 200 million news articles per year, depending on the application.

At component 504, the news risk alert generation module 302 may include at least one analytical AI/ML model to enrich each news article as it arrives. In some embodiments, the analytical AI/ML model may identify whether and which entities are mentioned in a news article and whether such a mention is significant and of economic/financial relevance. In an embodiment, the analytical AI/ML model may add a sentiment category (e.g., “negative”, “neutral”, “positive”) and/or a sentiment score (e.g., range −1 to +1). In some embodiments, the analytical model may add a probability of whether a news article mentions mergers and acquisitions activity in relation to mentioned entities. In some embodiments, the sentiment category, the sentiment score, and/or the probability of whether a news article mentions mergers and acquisitions activity in relation to mentioned entities may be provided as the signal used at component 512.

At component 506, the news risk alert generation module 302 may include a news article persister for storing news articles. In an embodiment, the news article persister may include a micro-service that stores each and every news article in real-time to a document database. The news article persister may send the news articles with a database record insert request. In an embodiment, each record may consist of a JSON document representing a news article that includes all the analytical data added at component 504.

At component 508, the news risk alert generation module 302 may include a main application document database for storing processed documents. In an embodiment, the document database supports full text queries and other Natural Language Programming (NLP) aspects. In some embodiments, the document database may store complex data structures, including nested data structures as a single record. In addition to a main document identifier (ID), additional attributes of the data structure may be indexed by the database for future querying. In some embodiments, the document database technology may include Elasticsearch or Open Search. In an embodiment, the database may hold two datasets: (1) the news articles; and (2) the time series as extracted at component 510. Each dataset may be stored in their own “partition” or “index” within the database. This allows the data to be queried independently.

At component 510, the news risk alert generation module 302 may include a time series extractor that may receive each and every news article in real-time. In an embodiment, for each article, the time series extractor may extract for each company each news article “signal” quantity value. These quantities may include, but are not limited to, (1) sentiment score and (2) mergers and acquisitions probability. This means that for 1 news article with n mentioned companies and m quantities, there will be 1×n×m time series values to be extracted. In some embodiments, time series records may be stored in the time series records “partition”/“index” in the document database. Each record may be associated with a “compound” primary key/identifier consisting of the date, company identifier, and the quantity. In an embodiment, the news risk alert generation module 302 may use a date to group all values for that day into a single record, rather than an exact point in time. In other words, multiple news article published at various times during a single day may be captured into a single time series record. A time series record may therefore be defined as a container/collection of all values within a single date (for a given company/entity and quantity).

In some embodiments, the fundamental data attributes of a time series record may be: (1) Date; (2) Company identifier; (3) Quantity type; (4) Collection of news article identifiers; and (5) Collection of quantity values, sequence matching the article identifiers under (4) above.

The above-described data model allows for rapid querying of time series records against long baseline periods, which is required for the news alerting analytical model at component 512. In an embodiment, the long baseline period may be between 3 and 12 months.

In some embodiments, in order to support rapid application development, each time series record may be retrieved conveniently from the database as a JSON document and deserialized into a language native representation. This process may be achieved through software libraries/SDKs for programming languages in use, such as Python or Java. These libraries may support rapid summary statistics extraction within a daily time series record. In some embodiments, the supported functions may include: (1) return all values; (2) return the mean value; (3) return the empirical cumulative distribution function; (4) return the inverse empirical cumulative distribution function; (5) return the percentile for values above a given threshold; (6) return the percentile for values below a given threshold; (7) count the number of values above a given threshold; (8) count the number of values below a given threshold; (9) return the value for a given percentile; and (10) return the value for a given count.

Additionally, at component 512, the time series extractor may include a micro-service that sends the time series records with a database insert to the document database. In some embodiments, the time series extractor micro-service may execute database insertion/update commands to allow high-speed and high-volume data processing. In an embodiment, the news risk alert generation module 302 may implement two techniques: (1) the time series extractor service may collect a defined limited number of news articles in-memory over a defined and strictly limited period of time (e.g., 10 seconds, 30 seconds, etc.). This number of news articles is referred to as a “mini batch”. Within this mini batch, all-time series values may be collected into their relevant daily containers (e.g., by date, by company, and/or by quantity type). Once these time series records have been constructed, the time series extractor service may send all records to the document database in a single command; and (2) multiple instances of the time series extractor service may be deployed to increase the processing capacity. Such a “horizontal scaling” is driven by an automated scaling algorithm driven by monitoring data which may include parameters such as CPU utilization and number of outstanding messages in the queue.

In some embodiments, to allow multiple instances of the service to process data for the same company without causing database insertion conflicts, a system of “optimistic concurrency control” may be used. This involves the service initially requesting from the database the sequence/version identifier for a given time series record. The service then appends any data to the record prior to issuing an insert/update command to the database. This command may send both the record data as well as the previously retrieved sequence identifier. If in the meantime, the same record was updated by a different instance of the service, the database may reject the out-of-sync version. In that case, the service may simply retry the same processing again after fetching the latest data from the database.

Also at component 510, the time series extractor may send the time series records to a dedicated message queue after they have been processed and stored in the database. This allows downstream consumers such as the news alerting analytical model at component 512 to use this queue as a trigger for real-time processing. New messages on this queue may indicate that there is a new quantity value for a given company for a given date to be processed. This allows news alerts to be evaluated and issued in real-time.

At component 512, the news risk alert generation module 302 may include a news alerting analytical model that evaluates whether newly arrived news articles should trigger the issue of a news alert for any company mentioned in the article with respect to each quantity type. Different analytical models may be deployed for each quantity type with dedicated models for sentiment-based alerting and mergers and acquisition activity-based alerting.

Additionally, at component 512, the news risk alert generation module 302 may include a time series database query model that computes, in real-time, the long-term baseline (e.g., 3 to 12 months) for a given company and a given quantity type, as and when the news articles arrive. To compute the baseline, the analytical model may query the time series records (daily containers) from the document database for the given company and quantity. Then using the software library, the model may compute for each day the required summary statistics. In some embodiments, the summary statistics may include the daily median sentiment score or the daily number of articles with a merger and acquisition classification probability over a certain threshold. The resulting baseline may then be compared with the current and recent quantity values to determine whether an alert should be issued. The news alerting analytical model may be re-trained and re-evaluated periodically or in real-time. Existing time series records stored in the database may be used flexibly without requiring a specific statistical quantity to be defined upfront.

At component 514, the news-based alerts may be sent to user-facing software applications using a message queue or similar technology. And, at component 516, news-based alerts may be sent to relevant users through electronic mail, instant messaging, or communication systems.

In some embodiments, the following features may be used to enable fast baseline data extraction and summary statistics calculation: (1) real-time global news article ingestion using a message queue with each news article being written to a unique location in a database or document store; (2) dedicated (micro)-service to process the same news article message queue with the purpose of extracting the relevant quantities (e.g., sentiment score, merger and acquisition probability, etc.) for each and every company; (3) This service may store each quantity as its own time series to the database where each data point represents a container of all values for a given day, for a given company. To improve processing speed, the service may collect a number of news articles as mini-batches and write the corresponding time series records batch-wise to the database quantities (e.g., sentiment score, merger and acquisition probability) for each and every company; (4) the time series storage service may be horizontally scaled by deploying multiple instances concurrently. When writing time series records to the database, optimistic concurrency is used allow the same record to be modified by multiple instances; (5) each daily container record may be loaded in a computer program as programming-language native objects with convenient functions to compute daily summary statistics such as min, max, median, quantiles, and/or cumulative distribution. If required to further improve data retrieval speed, commonly used summary statistics may be persisted to the database instead of being computed on the fly; and (6) the news alerting service may compute baseline summary statistics over a baseline period (e.g., between 3 and 12 months) in real-time, as and when news articles are received. The news alerting service may fetch for a given company and a given quantity (e.g., sentiment score) the relevant time series objects (i.e., daily containers) and extract a chosen summary statistic (e.g., median, count above/below a threshold, etc.) for each day. The statistical distribution of such a daily summary statistic may then be used to determine a suitable threshold for issuing an alert.

In some embodiments, the news risk alert generation module 302 may allow for efficient time series record data structures suitable for document/no-SQL databases. Additionally, the news risk alert generation module 302 may be optimized for fast querying while maintaining flexible summary statistics extraction. The news risk alert generation module 302 may also allow for integration with a real-time news alerting system for credit risk management.

Accordingly, with this technology, an optimized process for efficiently storing and retrieving news articles and associated analytical data/quantities to issue real-time alerts for managing credit risk is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for issuing news alerts with respect to an entity, the method being implemented by at least one processor, the method comprising:
receiving, by the at least one processor, a news article that relates to at least one entity;
analyzing, by the at least one processor, the news article in order to determine whether the news article contains important content;
when a determination is made that the news article contains important content as a result of the analyzing, determining, by the at least one processor, whether the at least one entity is mentioned in the news article;
determining, by the at least one processor, input parameters that relate to the at least one entity;
extracting, by the at least one processor from the input parameters, signal data;
generating, by the at least one processor, a news article electronic document including the news article and the signal data;
extracting, by the at least one processor from the news article electronic document, a signal quantity for each entity of the at least one entity;
generating, by the at least one processor, a time series of signal quantities for the news article;
storing, by the at least one processor, each of the news article electronic document and the time series in a database;
transmitting, by the at least one processor, the time series to a news alerting model that compares the signal quantity of each entity from the time series to a respective baseline value of the corresponding entity; and
generating, by the at least one processor, an alert message when the signal quantity exceeds the baseline value by a predetermined threshold value.

2. The method of claim 1, further comprising:
generating, by the at least one processor, a plurality of time series records for each entity, wherein each time series record of the plurality of time series records comprises each respective time series for a corresponding entity from each news article published during a first predetermined time period.

3. The method of claim 2, further comprising:
generating, by the at least one processor, the respective baseline value for the corresponding entity by querying the plurality of time series records for the respective entity over a second predetermined time period and computing at least one of a mean, median, standard deviation, count, and percentile.

4. The method of claim 1, wherein the time series includes at least one from among a date, an entity identifier, a quantity type, a news article identifier, and a quantity value that is sequence matched with the news article identifier.

5. The method of claim 1, wherein the signal data includes at least one from among a sentiment category, a sentiment score, and a probability of whether the news article mentions mergers and acquisitions activity related to at least one of the at least one entity.

6. The method of claim 1, wherein the determining of whether the at least one entity is mentioned in the news article, the analyzing of the news article to determine whether the news article contains important content, and the determining of the information that relates to a sentiment that relates to the at least one entity is performed by an artificial intelligence (AI) model that appends the signal data to the news article electronic document.

7. The method of claim 1, wherein the analyzing comprises determining whether the news article contains information that is negative with respect to the entity, and
wherein when a determination is made that the news article contains information that is negative with respect to the entity, determining that the information that is negative with respect to the entity is important content.

8. The method of claim 1, wherein the analyzing comprises determining whether the news article contains information that relates to merger and acquisition activity with respect to the entity, and
wherein when a determination is made that the news article contains information that relates to merger and acquisition activity with respect to the entity, determining that the information that relates to the merger and acquisition activity with respect to the entity is important content.

9. The method of claim 1, further comprising transmitting, by the at least one processor to a predetermined destination, the alert message and the signal data that corresponds to the news article such that a user interface associated with the predetermined destination is caused to display the transmitted information, and wherein the alert message includes a notification that the news article contains important content.

10. A computing apparatus for issuing news alerts with respect to an entity, the computing apparatus comprising:
a processor;
a memory; and
a communication interface coupled to each of the processor and the memory,
wherein the processor is configured to:
receive, via the communication interface, a news article that relates to at least one entity;
analyze the news article in order to determine whether the news article contains important content;
when a determination is made that the news article contains important content as a result of the analyzing, determine whether the at least one entity is mentioned in the news article;
determine input parameters that relate to the at least one entity;
extract, from the input parameters, signal data;
generate a news article electronic document including the news article and the signal data;
extract, from the news article electronic document, a signal quantity for each entity of the at least one entity;
generate a time series of signal quantities for the news article;
store each of the news article electronic document and the time series in a database;
transmit the time series to a news alerting model that compares the signal quantity of each entity from the time series to a respective baseline value of the corresponding entity; and
generate an alert message when the signal quantity exceeds the baseline value by a predetermined threshold value.

11. The computing apparatus of claim 10, wherein the processor is further configured to:
generate a plurality of time series records for each entity, wherein each time series record of the plurality of time series records comprises each respective time series for a corresponding entity from each news article published during a first predetermined time period.

12. The computing apparatus of claim 11, wherein the processor is further configured to:
generate the respective baseline value for the corresponding entity by querying the plurality of time series records for the respective entity over a second predetermined time period and computing at least one of a mean, median, standard deviation, count, and percentile.

13. The computing apparatus of claim 10, wherein the time series includes at least one from among a date, an entity identifier, a quantity type, a news article identifier, and a quantity value that is sequence matched with the news article identifier.

14. The computing apparatus of claim 10, wherein the signal data includes at least one from among a sentiment category, a sentiment score, and a probability of whether the news article mentions mergers and acquisitions activity related to at least one of the at least one entity.

15. The computing apparatus of claim 10, wherein the processor is further configured to:
determine whether at least one entity is mentioned in the news article, analyze the news article to determine whether the news article contains important content, and determine the information that relates to a sentiment that relates to the at least one entity by applying an artificial intelligence (AI) model that appends the signal data to the news article electronic document.

16. The computing apparatus of claim 10, wherein the processor is further configured to:
determine whether the news article contains information that is negative with respect to the entity, and
wherein when a determination is made that the news article contains information that is negative with respect to the entity, determine that the information that is negative with respect to the entity is important content.

17. The computing apparatus of claim 10, wherein the processor is further configured to:
determine whether the news article contains information that relates to merger and acquisition activity with respect to the entity, and
wherein when a determination is made that the news article contains information that relates to merger and acquisition activity with respect to the entity, determine that the information that relates to the merger and acquisition activity with respect to the entity is important content.

18. The computing apparatus of claim 10, wherein the processor is further configured to:
transmit, via the communication interface to a predetermined destination, the alert message and the signal data that corresponds to the news article such that a user interface associated with the predetermined destination is caused to display the transmitted signal data, and wherein the alert message includes a notification that the news article contains important content.

19. A non-transitory computer readable storage medium storing instructions for issuing news alerts with respect to an entity, the storage medium comprising executable code which, when executed by a processor, causes the processor to:
receive a news article that relates to at least one entity;
analyze the news article in order to determine whether the news article contains important content;
when a determination is made that the news article contains important content as a result of the analyzing, determine whether the at least one entity is mentioned in the news article;
determine input parameters that relate to the at least one entity;
extract, from the input parameters, signal data;
generate a news article electronic document including the news article and the signal data;
extract, from the news article electronic document, a signal quantity for each entity of the at least one entity;
generate a time series of signal quantities for the news article;
store each of the news article electronic document and the time series in a database;
transmit the time series to a news alerting model that compares the signal quantity of each entity from the time series to a respective baseline value of the corresponding entity; and
generate an alert message when the signal quantity exceeds the baseline value by a predetermined threshold value.

20. The storage medium of claim 19, wherein the executable code is further configured to cause the processor to:
generate a plurality of time series records for each entity, wherein each time series record of the plurality of time series records comprises each respective time series for a corresponding entity from each news article published during a first predetermined time period.
